(19) United States
(12) Patent Application Publication
(10) Pub. No.: US 2005/0021538 A1
(43) Pub. Date: Jan. 27, 2005

(54) Method and system for displaying a relational abstraction of a data store

(75) Inventors: Aaron Stephen Meyers, Provo, UT (US); Robert Alan Meyers, Orem, UT (US); Eric Stephen Meyers, Provo, UT (US)

Correspondence Address: Harrison Colter, Suite 310, 333 South 520 West, Lindon, UT, 84042, US

(73) Assignee: ActiveViews, Inc., Provo, UT (US)

(21) Appl. No.: 10/754,288

(22) Filed: Jan. 9, 2004

Related U.S. Application Data
(63) Continuation-in-part of application No. 10/627,180, filed on Jul. 25, 2003.

(51) Int. Cl. G06F 7/00

(52) U.S. Cl. 707/100

(57) ABSTRACT

A method and system for displaying a relational abstraction data store are disclosed. A relational abstraction of a data store is defined, the definition including a plurality of views, scalar or aggregate fields associated with the views, and relations between the views. The fields and relations associated with views are displayed and related to a base view through a sequence of relations. The fields displayed are constrained based upon the sequence of relations from the base view. Scalar fields are displayed where the sequence of relations does not contain a to-many relation. Aggregate fields are displayed where the sequence of relations contains at least one to-many relation. Distinct aggregate fields are displayed where the relation path sequence contains a to-many relation followed by a many-to-one relation. A field may be displayed with additional information indicating how, or whether, the fields may be used. The display of fields may be constrained in predetermined ways. The display of relations may be displayed with additional information about the nature of the relations and the sequence of the relation path. Fields and relations may be displayed using a hierarchical means of display such as in trees structures or lists, or may be displayed using a natural language description.

### CROSS REFERENCE TO RELATED APPLICATION

This application is a continuation-in-part of co-pending U.S. patent application Ser. No. 10/627,180 filed on Jul. 25, 2003 entitled “Method and System for Building a Report for Execution against a Data Store.” This prior application is incorporated herein by reference.

### BACKGROUND OF THE INVENTION

The present invention relates to information processing and more particularly to database access and reporting systems and methods relating to information processing.

Data access and reporting has long played an essential role in enterprise management. Without the ability to adequately access, summarize, and manipulate raw data the efficiency of an enterprise suffers. Traditionally, dedicated application programs perform specific data access and reporting.

Many of these database application programs are complex and unwieldy to use. A user often needs specialized knowledge to perform even basic tasks, and many simply cannot use prior solutions to build usable reports that provide answers to real or sophisticated questions. In large part, prior solutions are too complex, unwieldy and difficult to use because they provide field selection methods and systems that require a sophisticated understanding of the source data and how it is organized.

Prior solutions typically address field selection through the use of general programs that group fields according to predetermined logical groupings. These logical groupings greatly simply the field selection process by minimizing the number of fields displayed to the user at a given time. However, because prior solutions were not developed to extract what the user wants or what context the groupings and fields have to what the user wants, they are too difficult to use and may lead to inaccurate reports.

Prior solutions also have attempted to address field selection through the use of simplified interfaces known as program “wizards.” These wizards greatly simplify the field selection process by minimizing the number of options and/or inputs needed to create a report. However, because designers of these wizards presume that each wizard will be used to manipulate a particular type of data or a particular set of data, the simplified interfaces are inflexible and may lead to inaccurate or incomprehensible reports when applied to different data types or data sets.

Additionally, because dedicated database application programs, general report generator programs with limited field picking capabilities, and field selection wizards require extensive knowledge of underlying data structures, they are often prohibitively expensive. With prices in the hundreds or thousands of dollars per copy, and tens of thousands of dollars for an enterprise license, data access and reporting may be prohibitively expensive. This is especially true in the case of a small or start-up business.

Thus, there is a general need for a data access method and system that interactively and iteratively displays appropriate fields based upon what the user wants and thus quickly and efficiently constrains field selection in a simplified manner that is easily comprehended by a casual or novice user. There is also a need for a data access method and system that is inexpensive and affordable to individuals or small companies.

### SUMMARY OF THE INVENTION

According to the present invention, a method and system for displaying a relational abstraction of a data store is provided. The method and system empower novice or casual computer users easily and iteratively to select fields of the data store to create useful reports.

According to one embodiment, the present invention is implemented through a distributed application that runs on multiple computers but is displayed on a graphical user interface (“GUI”). This GUI, combined with common input devices such as a mouse and keyboard, minimizes the learning curve of applications made in accordance with the present invention. Thus, even a novice or casual user may quickly and easily understand and apply the present invention to access and build reports from a data store.

The present invention provides a simple-to-use application that displays fields associated with a data store. The fields associated with a data store are defined in a relational abstraction of the data store. The present invention provides an easily comprehended means of interactively and iteratively selecting fields defined in the relational abstraction, according to the user's desires in response to simple and efficient input commands. Using the invention, a user selects an initial view associated with the relational abstraction. This view, referred to herein as the base view, becomes the entry point into the relational abstraction and is used to constrain which fields are displayed for selection by the user. Selecting the base view is inherently understandable by users because the base view comprises the answer to what the user selects as the basis for a report. Based upon the base view, the user may select fields associated with any view of the relational abstraction, and may follow relations within the relational abstraction to select additional fields. As the user follows relations within the relational abstraction, the fields displayed are constrained by the base view and the relation path from the base view. Users thus have fields displayed for selection that are appropriate to answer the question associated with the base view.

The present invention defines a data store in terms of a relational abstraction. The relational abstraction generally parallels the entity-relationship inherent in a well designed transactional relational database. Doing so preserves the business logic associated with such transactional systems for use by users of the invention. One skilled in the art will readily recognize that an entity-relationship abstraction may also be applied to data storage systems that are not in the genre of traditional relational database management systems.

The relational abstraction includes views associated with a data store, scalar or aggregate fields associated with views and relations between views. View definitions identify tabular structures of rows and columns in the data store. Field definitions describe columns of data accessible in a particular view. Relation definitions describe associations between various views. Typically such definitions are associated with one or more tables and columns of a conventional relational database management system. However, one skilled in the art will recognize that any means of providing an entity-relationship view on data may be used as part of the invention.

The present invention permits a user to display only those fields that are logically available based upon the base view selected by the user and the relation path sequence followed by the user from the base view. If a relation path sequence contains only to-one relations, scalar fields are displayed. If a relation path sequence contains a to-many relation, aggregate fields are displayed. If a relation path sequence contains a to-many relation followed by a one-to-one relation, distinct aggregates are displayed.

Another benefit of the present invention comes from displaying fields with additional information indicating ways in which the fields may be used by the user. Aggregate fields can be displayed with information indicating that they can be used to generate totals. Fields predefined to be meaningful for grouping can be displayed as grouping fields. One skilled in the art will recognize that a field may be displayed any number of ways in accordance with the present invention.

Another benefit of the present invention comes from displaying default ways in which fields may be constrained. A default display of aggregate fields may be constrained to generate totals. A default display of groups meaningful for grouping may be constrained to grouping. One skilled in the art will recognize that the present invention permits the display of any number of defaults for display of a field.

Another benefit of the present invention comes from displaying the nature of relation paths from one view to another. Relation paths may be displayed as to-many relations where the relation path to a destination view contains a to-many relation sequence. Relation paths may be displayed as to-one where the relation path to a destination view contains a to-one relation sequence. Relation paths from a base view to a destination view may be displayed in the same manner. Relation paths containing a sequence of relations may also be displayed with additional information such as the existence of duplicate items in a destination view. One skilled in the art will recognize that any number of means to display relation paths and relation sequences may be included as part of the invention.

Another benefit of the present invention comes from providing the flexibility to display the relational abstraction of a data store in one or more ways. A relational abstraction may be displayed in a tree structure. A relational abstraction may be displayed in a list. One skilled in the art will recognize that any number of means may be used to display a relational abstraction in a hierarchical manner as part of the invention.

Another benefit of the present invention comes from displaying a sequence of relations that has been followed. By displaying the sequence of relations, the method and system apprises the user of the context associated with fields and relations available for selection. The sequence of relations may be displayed in a tree. The sequence of relations may be displayed in a list. The sequence of relations may be displayed using a natural language description. One skilled in the art will recognize that any number of means may be used to display a sequence or relations.

Another benefit of the present invention comes from providing means to help the user select fields appropriate to a particular purpose. Selectable fields may be limited to detail fields through the selection of a drop area. Selectable fields may be limited to measure fields through the selection of a button. Selectable fields may be limited to grouping fields through the selection of a menu item. One skilled in the art will recognize that any number of means may be used to display fields useful for particular purposes.

### BRIEF DESCRIPTION OF THE DRAWINGS

Other features and advantages of the present invention will be apparent from the following Detailed Description taken in conjunction with the accompanying Drawings, in which:

FIG. 1 is a block diagram of a distributing computing system that provides an exemplary operating environment for the present invention.

FIG. 2 is a tabular diagram of a sample database.

FIG. 3A is a tabular diagram of certain metadata software objects associated with the sample database depicted in FIG. 2.

FIG. 3B is a tabular diagram of certain metadata software objects associated with the sample database depicted in FIG. 2.

FIG. 3C is a tabular diagram of certain metadata software objects associated with the sample database depicted in FIG. 2.

FIG. 3D is a tabular diagram of certain metadata properties associated with one embodiment of the present invention.

FIG. 3E is a series of tables illustrating eXtensible Markup Language (XML) examples of metadata software objects associated with one embodiment of the present invention.

FIG. 4 is a main display window of an embodiment of the present invention.

FIG. 5 is a window display illustrating a software wizard used in an embodiment of the present invention.

FIG. 6A is a window display illustrating selection of a database according to an embodiment of the present invention.

FIG. 6B is a window display illustrating selection of a base view according to an embodiment of the present invention.

FIG. 7 is a window display illustrating various screen elements of the present invention, including a detail field drop area according to an embodiment of the present invention.

FIG. 8 is a window display illustrating a group field drop area according to an embodiment of the present invention.

FIG. 9 is a window display illustrating a measure field drop area according to an embodiment of the present invention.

FIG. 10A is a logic flow diagram illustrating a method for displaying fields and relations associated with a data store according to an embodiment of the present invention.

FIG. 10B is a logic flow diagram illustrating a method for displaying and selecting fields for inclusion in reports embodiment of the present invention.

FIG. 11 is a window display illustrating various screen elements of the present invention, including elements depicting relations, cardinality and field display constraints.

### DETAILED DESCRIPTION

The present invention may be embodied in a computer database access and reporting system that displays selected database data based upon base views, and the fields and relations associated with those base views. Selected database data is displayed on a display surface according to row, column, summary, group and filter criteria chosen by a user. The display surface is typically an active window on a display device of a simple application program, but the display surface may alternately be a window of a web browser or any application program operable for displaying and manipulating data. The display surface is typically a monitor, but may alternately be a printer, flatscreen LCD display, television, and so on.

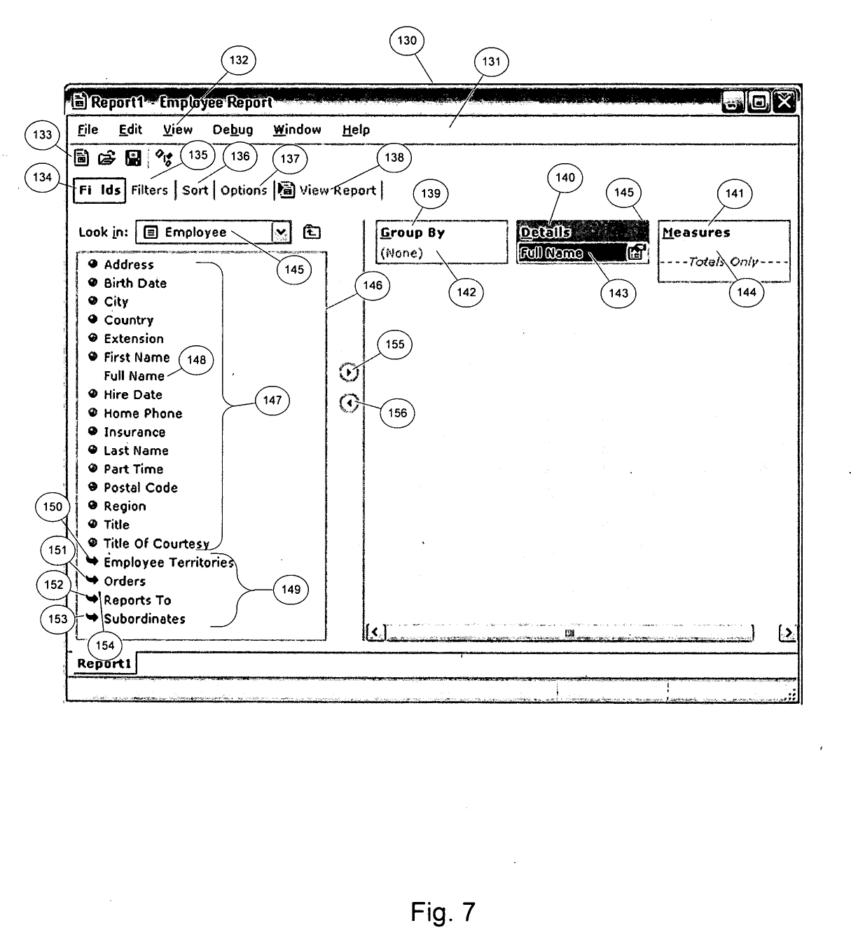

In one embodiment of the invention, a computer application includes a Query Construction Window 130 as depicted in FIG. 7. Referring to FIG. 7, the Query Construction Window 130 includes a Recursive Tree Structure 146, a Column Drop Area 143, a Group Drop Area 142 and a Measures Drop Area 144. The Recursive Tree Structure 146 is a display item used to display database views and associated fields and relations. According to one embodiment of the present invention, the Recursive Tree Structure 146 is displayed at the left of the Query Construction Window [ ] and is column-shaped. The Group Drop Area 142 is a display item used for adding fields from the Recursive Tree Structure 146 to create row groupings of a report, is typically located to the right of the Recursive Tree Structure 146, and is column-shaped. The Column Drop Area 143 is a display item used for adding fields from the Recursive Tree Structure 146 to create columns of a report, is typically located to the right of the Group Drop Area 142, and is column-shaped. The Measures Drop Area 144 is a display item used for adding fields from the Recursive Tree Structure 146 to create summary or total fields of a report, is typically located to the right of the Column Drop Area 143, and is column-shaped. Alternate embodiments may use different means of displaying and selecting the names of database fields and relations. Alternative embodiments may also use more drop areas, or a single drop area, or any other means of displaying fields and relations. Alternate embodiments may also change the shape of the drop area display items to fit various displays; for example, the drop areas may be round, square, triangular, or a custom shape as needed, or may be located in a pull-down menu or in some other type of user interface configuration. For example, the drop areas may be located in combined windows on the display screen, or may be represented by icons or buttons rather than blank fields.

A user may also add columns to a report by selecting fields. Referring to FIG. 7, to add columns, a user selects a Column Drop Area Heading 140, which selection identifies to the system that the user desires to add columns to a report, whereupon the system displays a list of fields in the Recursive Tree Structure 146 that corresponds to the base view of the associated relational abstraction. The user then adds fields to the Column Drop Area 142 by initiating a drag-and-drop command or by double-clicking the desired field, or by clicking an Arrow-Transfer-Button 155. The system captures this action by adding the field to the list of columns and by displaying the selected field name in the Column Drop Area 143.

A user may also add row groupings to a report. To add row groupings, a user selects a group field from the list of fields in the Recursive Tree Structure 146 and drops the field in the Group Drop Area 142 by initiating a drag-and-drop command, or, provided the Group Drop Area 142 is active, by double-clicking the desired field, or by clicking the Arrow-Transfer-Button 156. The system captures this action by adding the field to the list of row groupings and by displaying the selected field name in the Group Drop Area 142.

A user may also add numeric summary or aggregation measures to a report. To add measures, a user selects an aggregation or measures field from the list of fields in the Recursive Tree Structure 146 and drops the field in the measures drop area by initiating a drag-and-drop command, or, provided the measures drop area is active, by double-clicking the desired field, or by clicking the Arrow-Transfer-Button 156. The system captures this action by adding the field to the list of measures and by displaying the selected field name in the Measures Drop Area 144.

Likewise, a user may add fields from related database views to a report. Typically, the Recursive Tree Structure 146 will include a list of relations defined in the relational abstraction. To add fields from a related view, a user initiates a double-click command on a relation. The system will respond by replacing the previously existing list of fields and relations in the Recursive Tree Structure 146 with a new list based upon the selected relation and the cardinality existing between the base view and the destination view of the relation. The user may then add fields from the Recursive Tree Structure 146 to the Column Group Area 143, Group Drop Area 142 or Measures Drop Area 144, as noted above.

Once a user has selected the desired fields to be grouped and displayed in a report, the user may choose to view a corresponding report. In the present invention, the list of fields and relations displayed for selection by a user is based upon a base view. Typically, the system will retrieve a list of tables and views from a database server and display them on a display surface. A user may then select one of the tables or views. Based upon the user's selection, the system will display a relational abstraction of all tables, views, fields and relations of the selected database table using the base view as a starting point.

As used herein, a “user” refers not only to a person using the present invention, but also to a program, application, operating system, function call, or any other entity that may make use of the present invention. Thus, an operating system that manipulates or otherwise employs the present invention may be classified as a user.

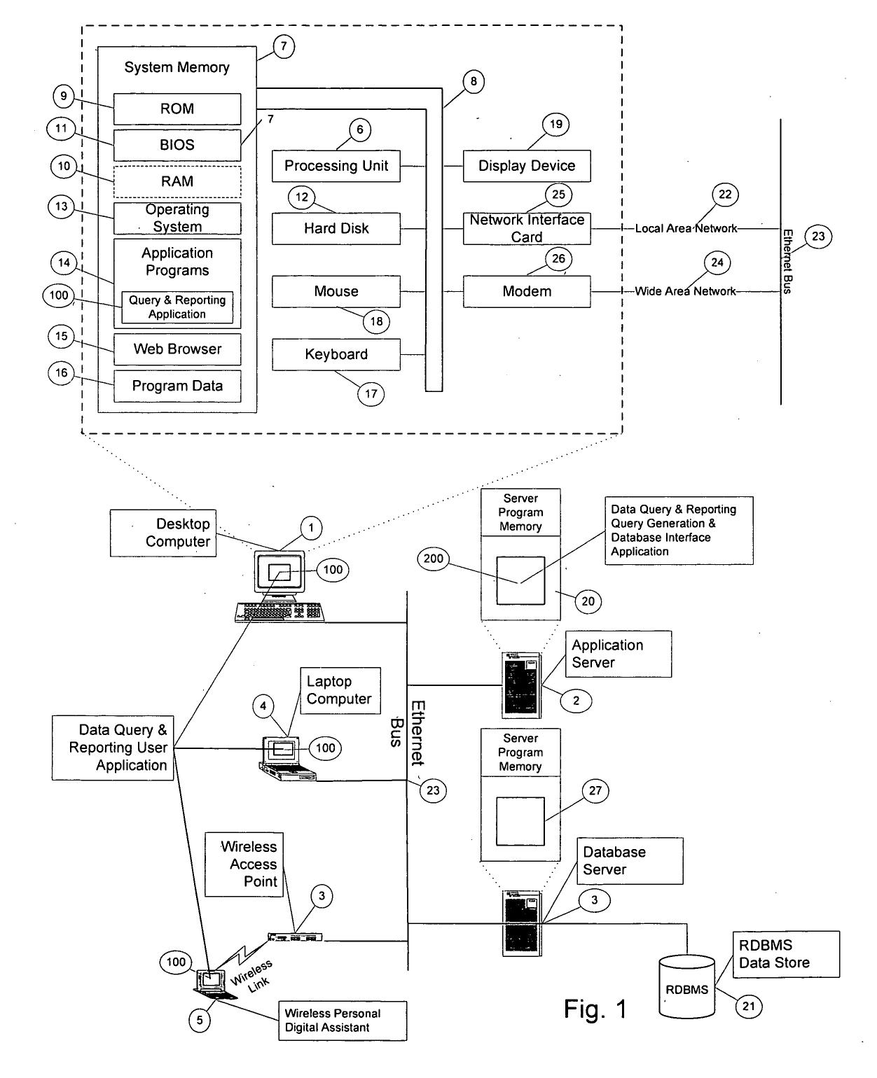

FIG. 1 diagrammatically depicts a suitable computing environment in which various embodiments of the present invention may be implemented. While the invention is described in the general context of application programs running on operating systems in a distributed computing environment where tasks are linked through a communications network, those skilled in the art will recognize that the invention also may be implemented in varying types of computer environments, including desktop computers, laptops, hand-held devices, multiprocessor systems, microprocessor-based or programmable consumer electronics, minicomputers, mainframe computers, and the like. In a distributed computing environment, application programs may be located in both local and remote memory storage devices.

With reference to FIG. 1, according to one embodiment of the present invention, a computer system for implementing the invention includes a conventional Desktop Computer 1, an Application Server 2 and a Database Server 3. Typically, the Desktop Computer 1, the Application Server 2 and the Database Server 3 will operate in a networked environment using logical connections. Although FIG. 1 depicts a system including a Desktop Computer 1, it will be appreciated by those skilled in the art that other types of computing devices such as a Laptop Computer 4, or a Personal Digital Assistant 5, may also be used.

Typically, the Desktop Computer 1 includes a Processing Unit 6, System Memory 7, and a System Bus 8 that couples the System Memory 7 to the Processing Unit 6. The System Memory 7 includes Read Only Memory (ROM) 9 and Random Access Memory (RAM) 10, and a Basic Input/Output System (BIOS) 11 that contains the basic routines that help to transfer information between elements within the Desktop Computer 1, such as during start-up, and the ROM 9. The Desktop Computer 1 further typically includes a Hard Disk Drive 12 connected to the System Bus 8. Hard Disk Drive 12 and its associated computer-readable media provide nonvolatile storage for the Desktop Computer 1. Although the description of computer-readable media above refers to a hard disk, it will be appreciated by those skilled in the art that other types of storage devices and media that are readable by a computer, such as a removable magnetic disk, a CD-ROM disk, a magnetic cassette, a flash memory card, a digital video disk, Bernoulli cartridge, and the like, may also be used included in, or attached to, the Desktop Computer 1.

A number of program modules may be stored in the Hard Disk Drive 12 and the RAM 10, including an Operating System 13, one or more Application Programs 14, a Web Browser Program 15, and Program Data 16. These program modules include a Data Query And Reporting User Application (“DQR Application”) 100 configured for implementing an embodiment of the present invention. A user may enter commands and information into the Desktop Computer 1 through conventional input devices such as a Keyboard 17 or a pointing device such as a Mouse 18. Other input devices (not shown) may include a pen, touch-operated device, microphone, joystick, game pad, satellite dish, scanner, or the like. A Display Device 19, such as a display screen, is also connected to the System Bus 8 via an interface. In addition to the Display Device 19, desktop computers typically include other peripheral output devices (not shown), such as speakers, scanners or printers.

The Application Server 2 and the Database Server 3 may be personal computers, minicomputers or mainframe computers, or another common application platform, and may also include many or all of the elements described relative to the Desktop Computer 1. The logical connections depicted in FIG. 1 may include a Local Area Network (LAN) 22 or a Wide Area Network (WAN) 24 running over an Ethernet Network Bus 23. Such networking environments are commonplace in offices, enterprise-wide computer networks, intranets and the Internet. Typically, the Database Server 3 stores and manages data by means of a special set of files or folders, such as an RDBMS Data Store 21, and makes that data available to other computer programs through the Application Programming Interface 27, which runs in the Server Program Memory 28 of the Database Server 3.

When used in a typical networking environment, the Desktop Computer 1 is connected to the LAN 22 through a Network Interface Card 25. When used in a WAN networking environment, the Desktop Computer 1 typically includes a Modem 26 or other means for establishing communications over the WAN 24, such as the Internet. The Modem 26, which may be internal or external, is connected to the System Bus 8. In a networked environment, Application Programs 20, or portions thereof, may be executed on the Application Server 3 and stored in the server memory and storage devices. These application programs include a Data Query And Reporting Query Generation And Database Interface Application (“Query Engine”) 200 configured for implementing an embodiment of the present invention. Typically, the Query Engine 200 also includes an intermediate mapping or metadata layer that is used when communicating with a database server. It will be appreciated that the network connections shown are exemplary and other means of establishing a communications link between the computers may be used.

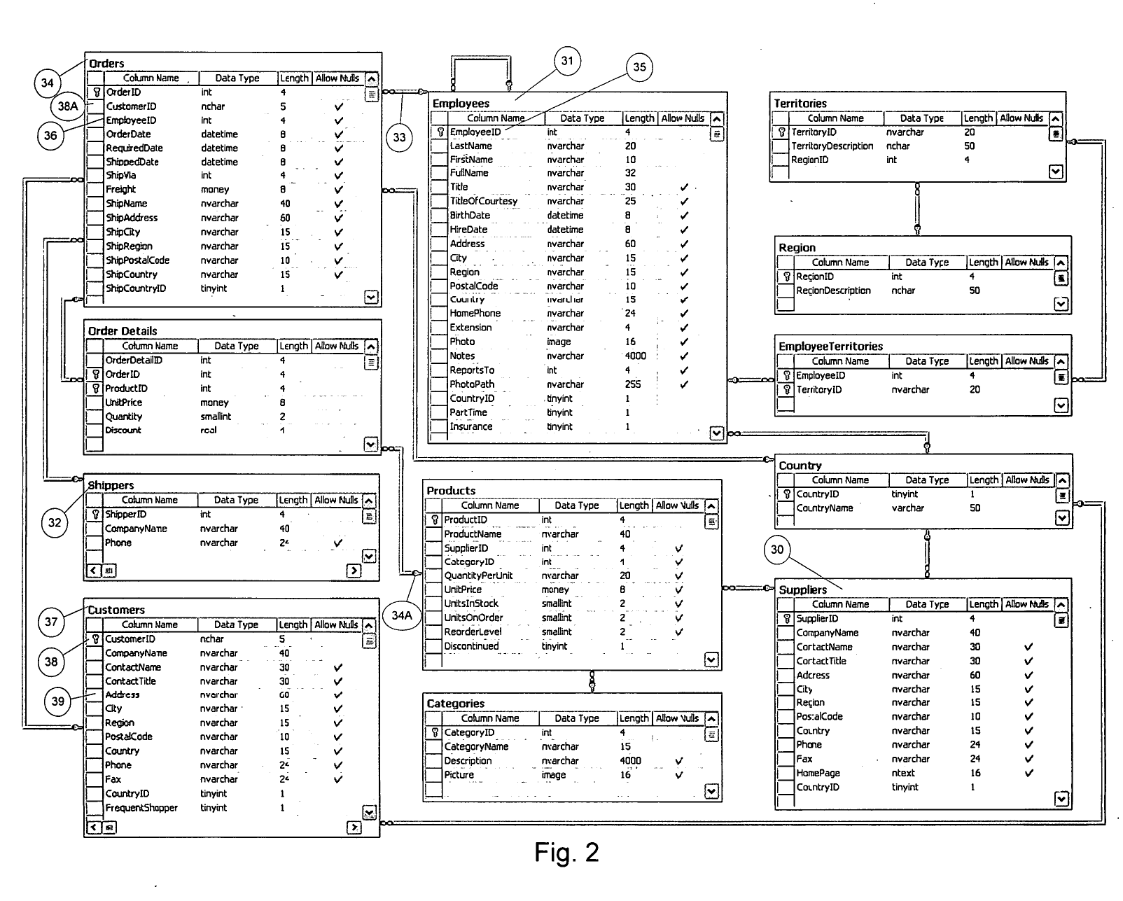

FIG. 2 is a block diagram illustrating the main tables, fields and the relations of a sample database, which has been derived from the Northwind database provided by Microsoft Corporation with its database server products. This modified Northwind database is used extensively in the embodiments illustrated below to show how the various embodiments of the DQR Application 100 and the Query Engine 200 interact with the Data Store 21. Tables in the database are depicted in the large blocks of FIG. 2, such as a Suppliers Table 30, an Employees Table 31 and a Shippers Table 32. FIG. 2 also depicts connector lines between the tables to designate relations, such as a Relation 33 between the Employees Table 31 and the Orders Table 34. As depicted in FIG. 2, a key symbol such as the Key Symbol 34A and the infinity symbol (∞) designate the cardinality of relationships. Such key symbols depict a “one-to” or a “to-one” relationship, and the infinity symbol designates a “many-to” or “to-many” relationship. Thus, the cardinality of the Relation 33 is expressed as one-to-many from the perspective of the Employees Table 31 in FIG. 2. As also shown in FIG. 2, the Relation 33 is linked between the EmployeeID Field 35 in the Employees Table 31 and the Employee ID Field 36 in the Orders Table 34.

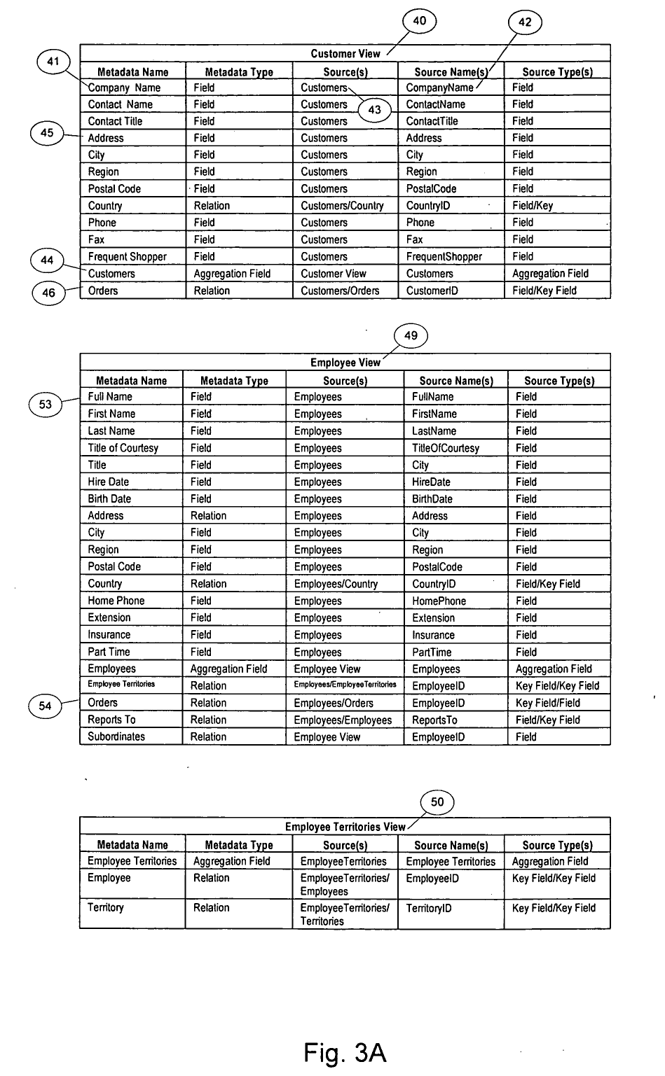

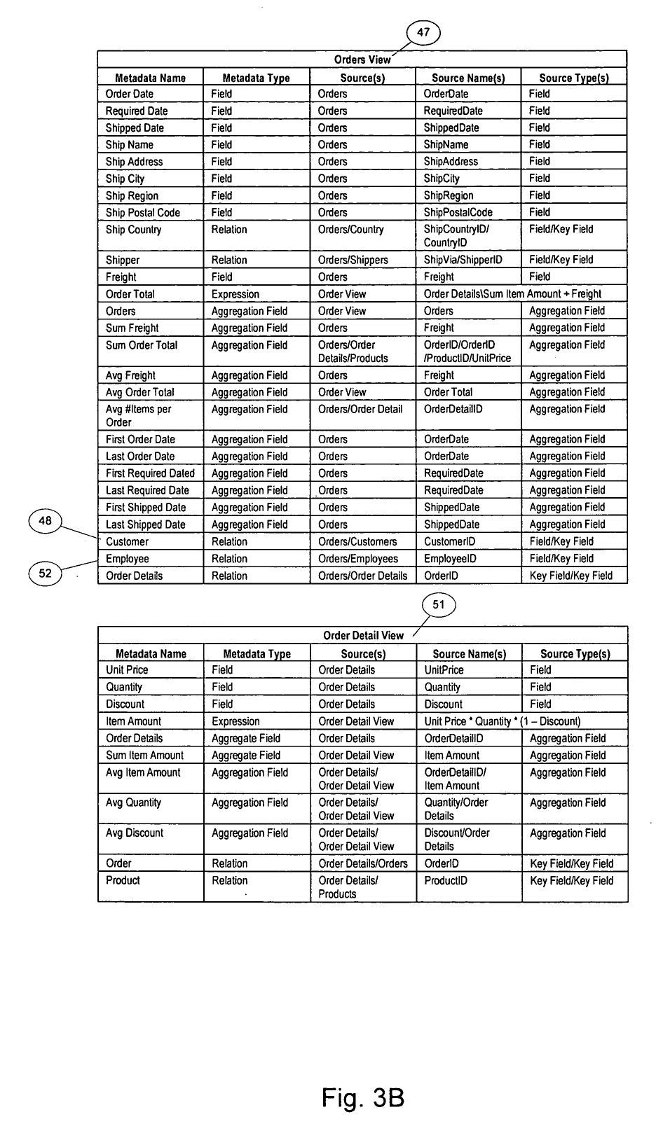

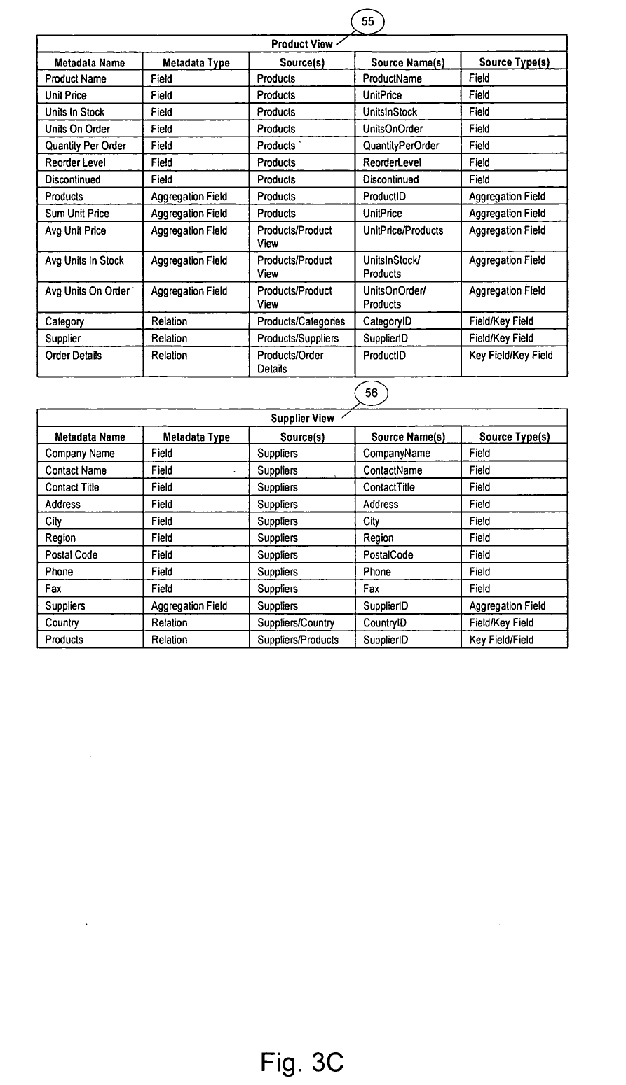

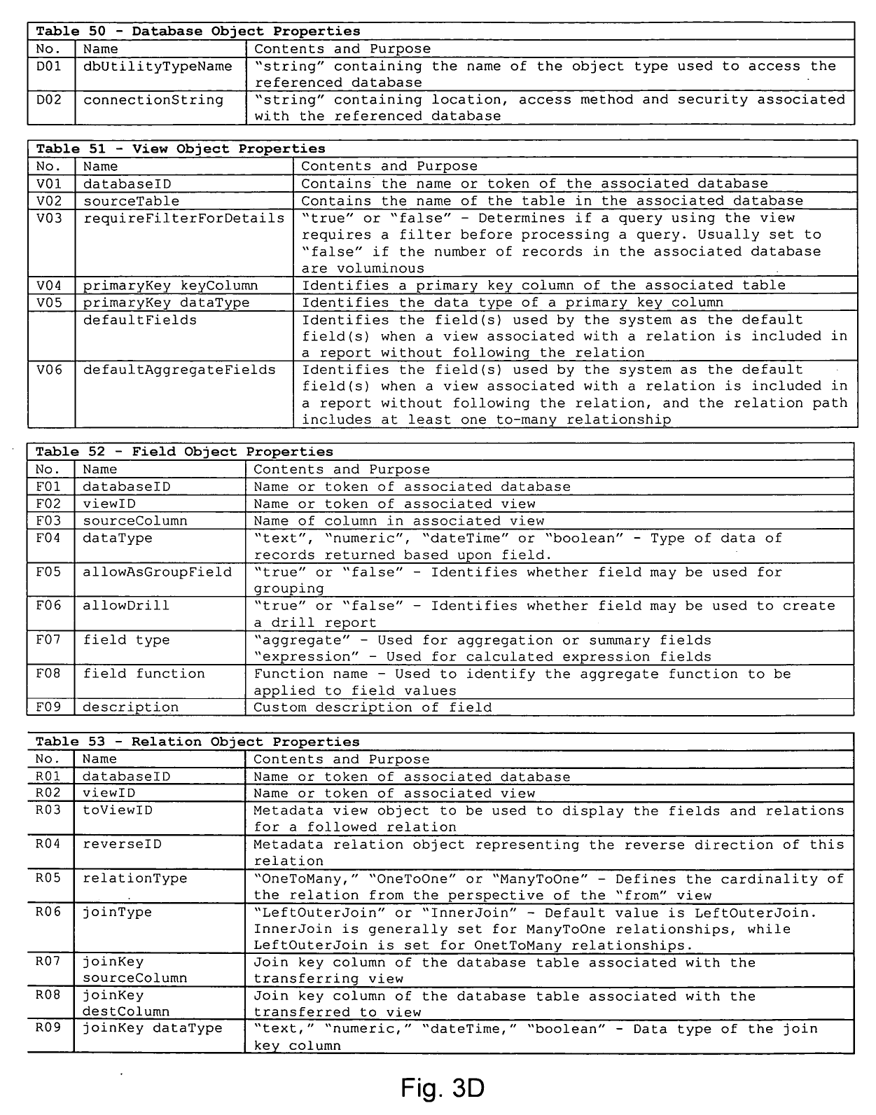

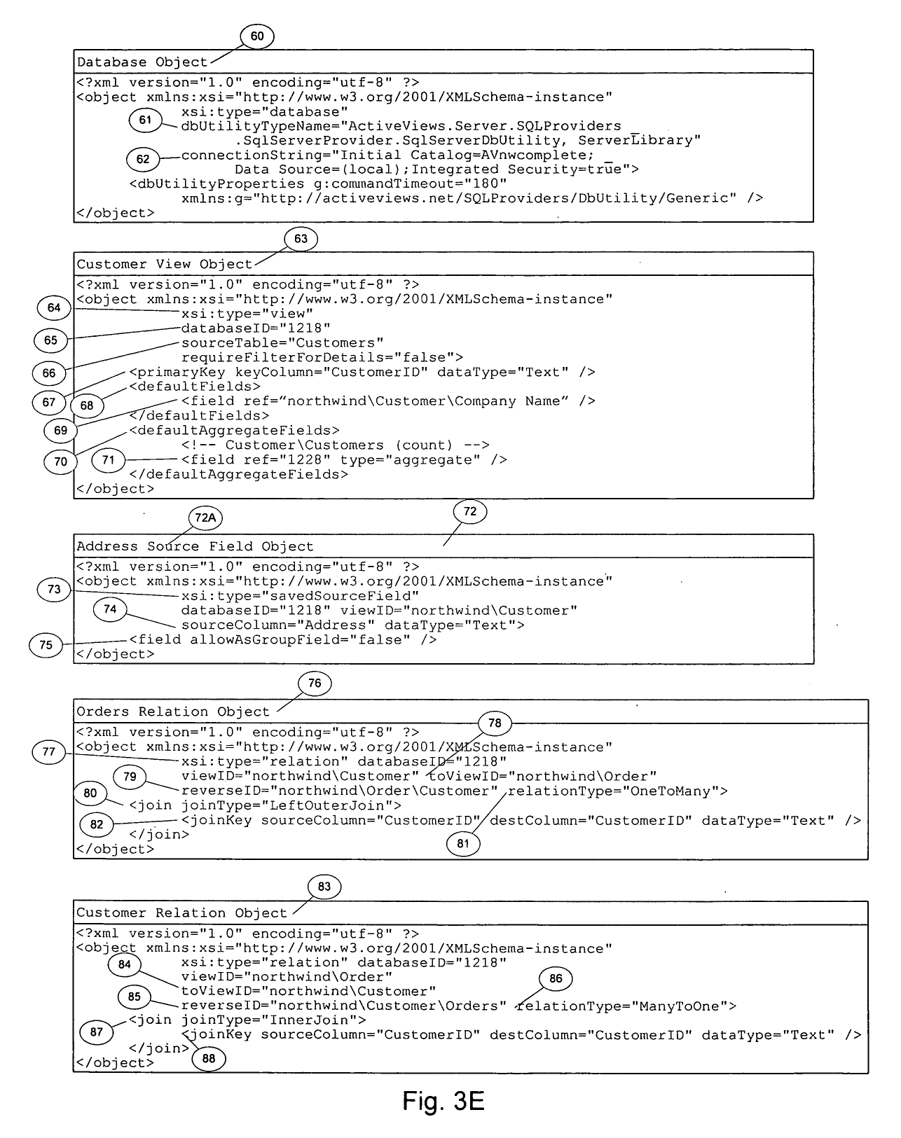

FIG. 3A, FIG. 3B and FIG. 3C are tables illustrating the mappings between the sample Northwind database tables, columns and relations and the views, fields and relations of the DQR Application 100 and the Query Engine 200, as used in one embodiment of the present invention. Such mappings are known by those skilled in the art as metadata, or data describing other data. Typically, metadata mappings are constructed by personnel familiar with a data store and the data contained therein.

In the present example metadata, a “Customer View” Table 40 depicts a mapping between the sample Northwind database described in FIG. 2 and the DQR Application 100. Referring to the Customer View Table 40 in FIG. 3A, a Company Name Field 41 is mapped to a CompanyName Field 42 in the Customers Table 37 of FIG. 2, as denoted by Balloon Number 43 in FIG. 3A. One skilled in the art will recognize the mappings between the metadata denoted in FIG. 3A, FIG. 3B and FIG. 3C and the tables, columns and relations of FIG. 2.

FIGS. 3D and 3E further disclose the organizational structure of the metadata. Metadata for a database is organized in a specific manner to facilitate use thereof. In one embodiment of the present invention, metadata is organized through at least four specific software objects. Such objects have methods and properties associated with them. Table 50 of FIG. 3D describes properties associated with database objects. For example, an Object Property dbUtilityTypeName D01 references a string containing the name of the object type used to access the referenced database, which could be a name readily understandable by humans or an alphanumeric reference to the database. An Object Property connectionString D02 references a string containing the location, access method and security associated with a database. One skilled in the art will recognize that other property names and property types could readily be substituted for those presented in FIG. 3D. Further, one skilled in the art will also recognized that other software conventions such as functions, structures and the like could be used instead of objects.

According to one embodiment of the present invention, instances of the objects described in FIG. 3D are implemented through use of extensible Markup Language 1.0 (“XML”). Table 60 of FIG. 3E includes an XML description of an instance of the database object described in the Table 50 for the Northwind sample database described in FIG. 2. Referring to FIG. 3E, note that a dbUtilityTypeName Property 61 specifies that SQL Server is the access method for the Northwind database. Note also that a connectionString Property 62 indicates the Northwind database is located on the local machine and accessed through integrated security. One skilled in the art will readily recognize that different database access service providers and securities interfaces may be used.

As shown in FIG. 3E, a Table 63 includes the XML description of an instance according to the description of the Table 51 of the Customer View 40. In one embodiment of the present invention, each view described by the metadata has a corresponding XML object definition. In the Table 63, a xsi:type=“view” Tag 64 specifies the object as a view object; a databaseID=“1218” Tag 65 specifies a shorthand notation referencing the modified Northwind database; and a sourceTable=“Customers” Tag 66 indicates that the Customer View is mapped to the Customers Table 37 in FIG. 2. A <primaryKey keyColumn=“CustomerID” dataType=“Text”/> Tag 67 indicates that the key field for the Customer View 40 is the CustomerID Field 38. A<defaultFields> Tag 68 enumerates the source fields displayed when the user fails to specify a field after following a relation that terminates on the Customer View 40. In the present case, an XML Tag <field ref=“northwind\Customer\Company Name”/> 69 references the Company Name Source Field 41 of FIG. 3A. An XML Tag <defaultAggregateFields> 70 enumerates the source fields containing numeric values associated with the Customer View 40, which are available for providing numeric summaries of data contained in a report. In the present embodiment, an XML Tag <field ref=“1228” type=“aggregate”/> 71 references the Customers Aggregation Field 44 of FIG. 3A.

Table 72 of FIG. 3E provides an XML description of the Address Field 45 of the Customer View 40 of FIG. 3A and the Customer View XML Object 63 in FIG. 3E. In one embodiment of the invention, each source field to be exposed for a view is similarly defined. An xsi:type=“savedSourceField” XML Tag 73 identifies an Address Object 72A as a data or source field. The sourceColumn=“Address” XML Tag 74 identifies the Address Field 39 as the data source for the Address Object 72A.

As shown in FIG. 3E, an Orders Relation Object Table 76 is an instance of a relation object conforming to the Relation Object Properties Table 53, which provides an XML description of the Orders Relation 46 of FIG. 3A. According to one embodiment of the invention, each relation is similarly defined. Referring to the Orders Relation Object Table 76 of FIG. 3E, an xsi:type=“relation” Tag 77 defines the object as a relation object. The relation definition also includes a ViewID=“northwind\Order” Property 78, which in the present embodiment indicates that following a relation from the Customer View 40 to the Order View 47 will expose the fields and relations associated with the Order View 47. A reverseID=“northwind\Order\Customer” Property 79 indicates, should the Orders Relation 46 be followed, that the path back to the Customer View 40 will occur through use of the Customer Relation 48. A relationType=“OneToMany” Property 81 indicates that the relation from the Customer View 40 to the Order View 47 is one-to-many.

The join type and the join keys for the Orders Relation Object Table 76 are specified by a joinType=“LeftOuterJoin” property 80 and a <joinKey sourceColumn=“CustomerID” destColumn=“CustomerID” dataType=“Text”/> XML Tag 82, respectively. In this case, because the relationship is identified as a one-to-many relation, the join is specified as a left outer join. A left outer join of the Customer View 40 and the Order View 47 will include all records from the Customers Table 37 and the corresponding records in the Orders Table 34 where the CustomerID 38 and the CustomerID 38A are equal.

A Customer Relation Object Table 83 of FIG. 3E includes an XML description of the Customer Relation 48 of the Order View 47 of FIG. 3B. The Customer Relation Object Table 83 represents the reverse path associated with the Orders Relation 46. In this case, a toViewID=“northwind\Customer” Property 84 points to the Customer View 63, a reverseID=“northwind\Customer\Orders” Property 85 points to the Orders Relation Object Table 76, a relationType=“ManyToOne” Property 86 indicates that the relation is many-to-one, and a joinType=“InnerJoin” Property 77 indicates that the join is an inner join. An inner join includes records from both the Orders Table 34 and the Customers Table 37 where the values of the join keys specified by a <joinKey sourceColumn=“CustomerID” destColumn=“CustomerID” dataType=“Text”/> XML Tag 88 are equal.

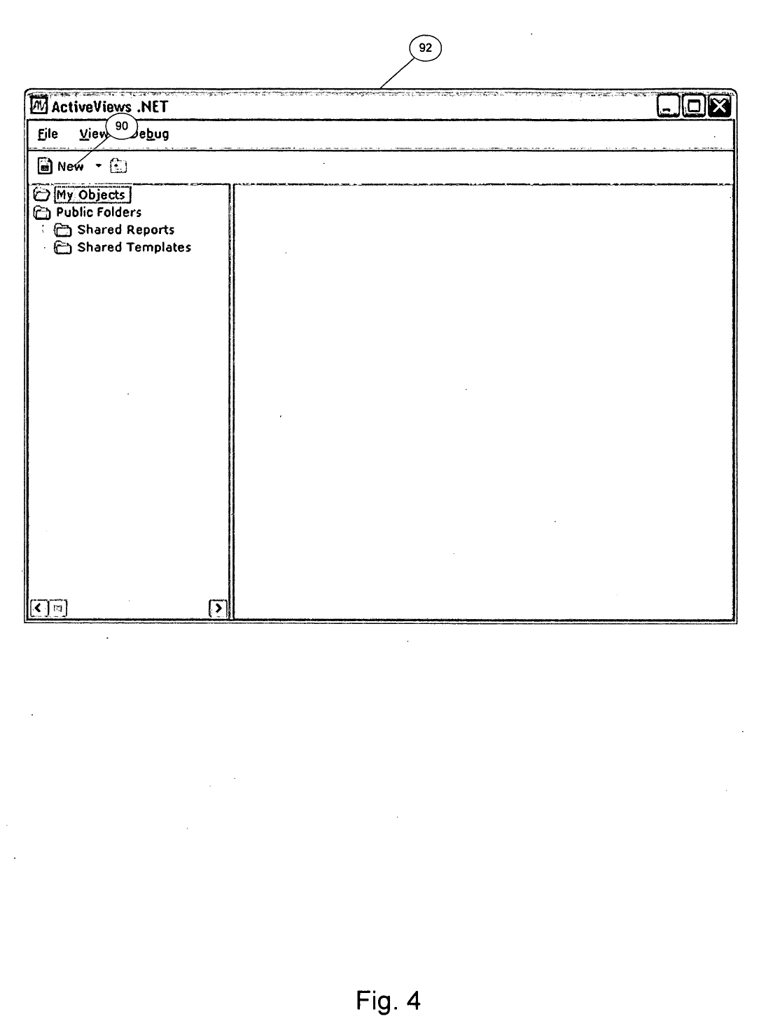

The present invention provides means to interactively and iteratively display fields for selection. FIG. 4 depicts a main or initial display Window 92 of an embodiment of the DQR Application 100. From this Window 92, a user of the DQR Application 100 may select a New Button 90 to create a new report.

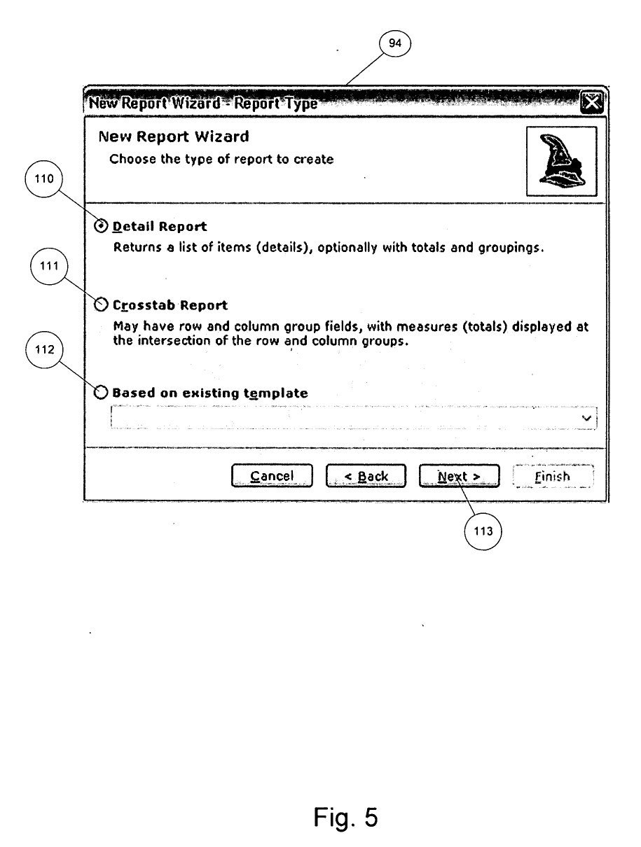

FIG. 5 depicts a display Window 94 according to one embodiment of the DQR Application 100 that is useful for guiding a user through the process of selecting fields for a report. One skilled in the art will appreciate that various other interfaces may be used to facilitate creation of a report, including a menu-drive interface, a programmatic interface, a verbal interface, etc. In the embodiment shown, a user may select a Detail Report Radio Button 110 to create a new detail report. A detail report in the depicted embodiment is a list based upon one or more source fields of a database view. In this embodiment, a user may also select a Crosstab Report Radio Button 111 to create a tabulated report based upon the intersection of two source fields that bear a many-to-many relationship to each other. A user may also select a Based Upon Existing Template Radio Button 112 to create a report based upon a previously saved report or template. Once a user has selected a report type, the user may select a Next Button 113 to proceed to the next step in creating a report. A user may also select a Cancel Button 114 to stop building a report, or may select a Back Button 115 to return to the Window 92.

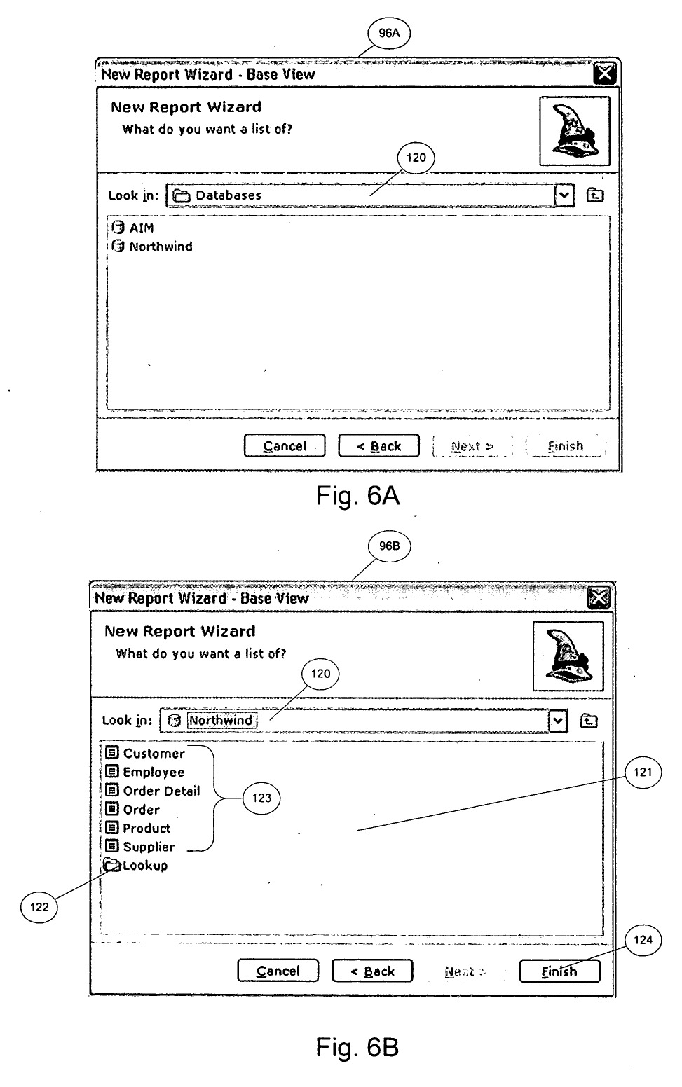

FIGS. 6A and 6B depict display Windows 96A and 96B, respectively, of an embodiment of the DQR Application 100 that allows a user to select a database view as the base view for use in a list type report. The user may select a database known to the DQR Application 100 and the Query Engine 200, as described by metadata associated with the database (an example of which is provided in FIGS. 3A-3E) by selecting one of the databases included in a Look In Drop Down Box 120. In the depicted embodiment, once a user has selected a database, the views associated with the database as described by the metadata are displayed in a View List 121 of FIG. 6B. In the present example, the views described in FIGS. 3A-3C appear in the View List 121.

In the depicted embodiment, views may be organized into subfolders, such as a Lookup Folder 122. This facility is provided for databases having a large number of defined views. In the depicted embodiment of the present invention, a base view is set by selecting a view from a List 123 and either selecting a Finish Button 124 or double-clicking on the selected view. This base view, in conjunction with the associated metadata described in FIGS. 3A-3C, as exposed by the Query Engine 200 and the DQR Application 100, is used to display fields and relations associated with a relational abstraction of the database relative to the selected base view.

A relational abstraction of the present invention may be exposed through a display system and according to rules of the invention enforcing proper display. FIG. 7 depicts a Query Construction Window 130 of the display system according to one embodiment of the DQR Application 100. Those skilled in the art will recognize that the Query Construction Window 130 is a conventional window of a modern desktop application. However, those skilled in the art will also recognize that other conventional and non-conventional display means, screens and windows could be used. In the depicted embodiment, a Menu Bar 131 contains several menu items, including a View Menu Item 132, which in one embodiment of the invention shows the iterative nature of queries generated. A Toolbar 133 contains a Filters Button 135, a Sort Button 136, an Options Button 137 and a View Report Button 138. The Toolbar 133 and related buttons are used in this embodiment of the invention to display certain windows, fields and relations.

A Group By Box 139, a Details Box 140 and a Measures Box 141 are standard label boxes. The boxes below the Group By, Details and Measures areas of the Query Construction Window 130, numbered respectively 139, 140, and 141, are drop box areas where a user may drag or locate fields when building queries. Note that in the depicted embodiment, a Details Drop Box Area 143 has been selected by default, as denoted by the darker gray colored background surrounding the Details Label 140. With such selection, a user may select from a Selection Area 146 one or more fields from a Field Group 147 that pertain to an Employee View 49 (see FIG. 3A), which is the view based upon the Employees Table 31 of the FIG. 2, as shown in a Look In Drop Down Box 145 of FIG. 7. In the depicted embodiment and present example the base view is based upon Employee View 49 and only scalar fields associated with Employee View 49 are displayed. One such scalar field is a Full Name Source Field 148, which has been selected according to the present invention as shown in the Details Drop Area 143. Because Employee View 49 is the base view, Look in: Box 145 displays only a textual representation of Employee View 49, indicating that the sequence of relations for Employee View 49 from the base view is empty.

In the present example, a user may also follow relations between the Employee View 49 and the other views described in FIGS. 3A-3C, including an Employee Territories Relation 150, an Orders Relation 151, a Reports To Relation 152 and a Subordinates Relation 153. In the present example, the Reports To Relation 152 is visually designated as a to-one relation, as denoted by a superscripted “1.”

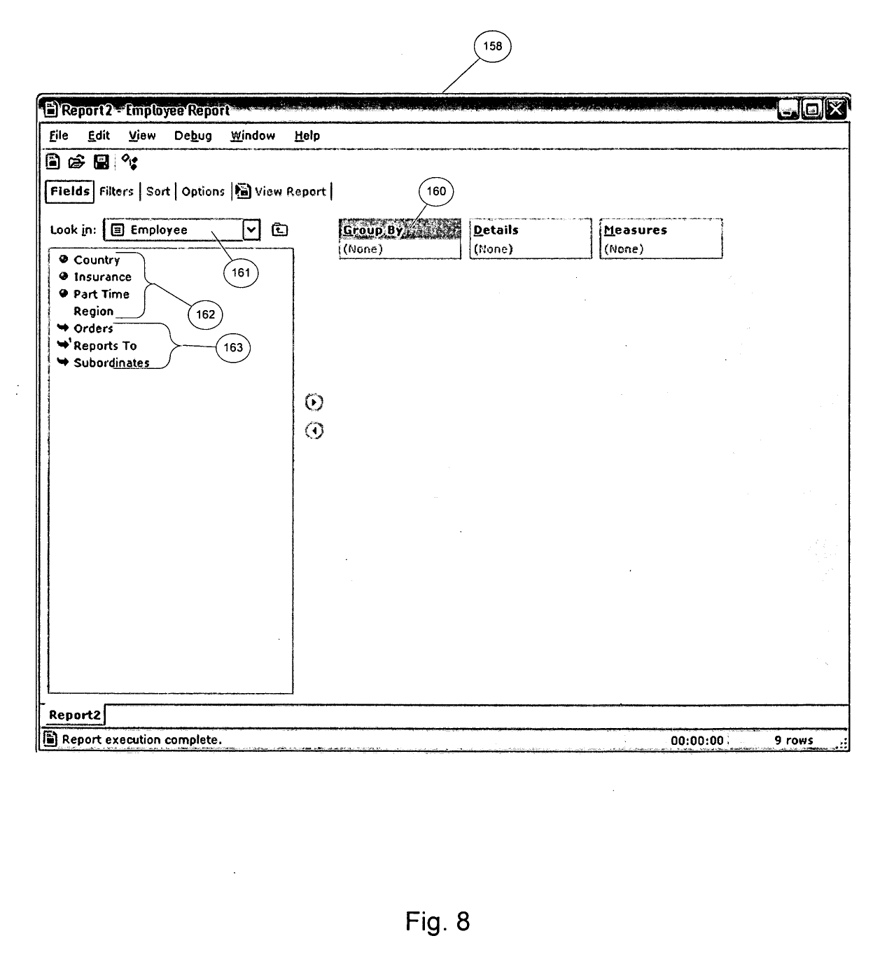

FIG. 8 depicts a display Window 158 of an embodiment of the DQR Application 100 that illustrates selection of a Group By Drop Area 160. When the Group By Drop Area 160 is selected, the DQR Application 100 displays only those fields of the Employee View 49 as are designated in a Look In Drop Down Box 161 that can be used for grouping. Each such field will have been designated previously as a field available for grouping by setting an allowAsGroupField Property F05 (see FIG. 3D) in the metadata object associated with the field to true. In the present example, the fields highlighted by Balloon 162 of FIG. 8 may be selected and the relations highlighted by Balloon 163 may be followed.

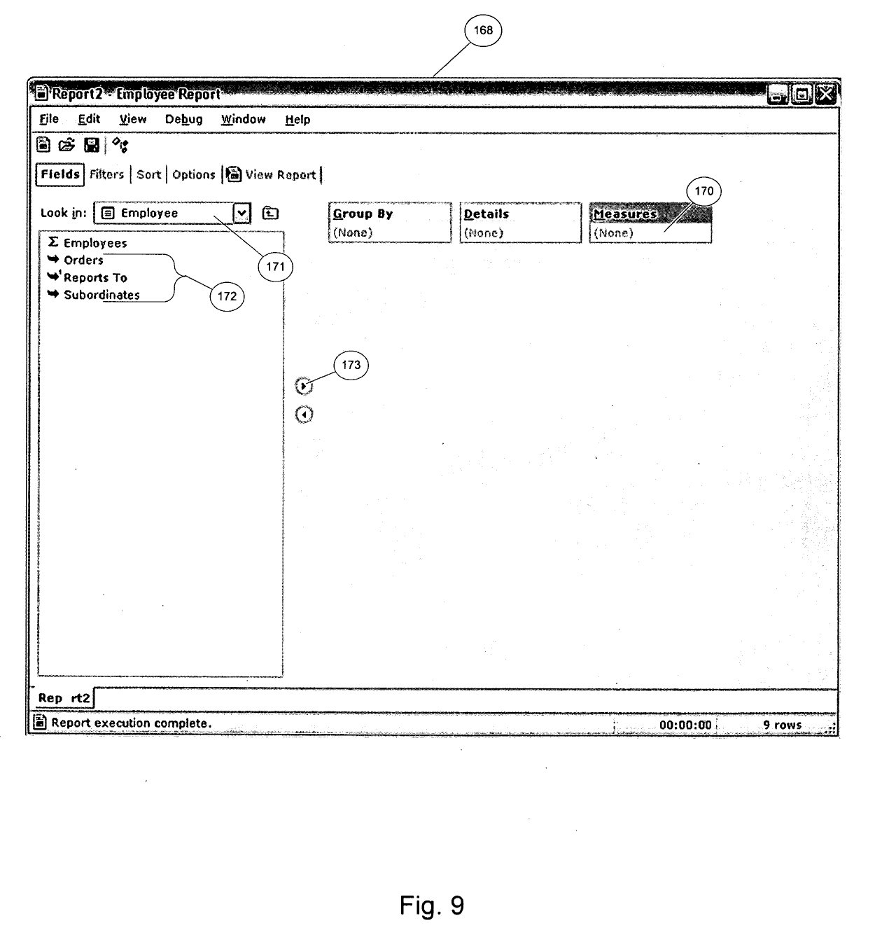

FIG. 9 depicts a Display Window 186 of an embodiment of the DQR Application 100 illustrating selection of a Measures Drop Area 170. In the depicted embodiment, the Measures Drop Area 170 provides a means to incorporate numeric summaries or totals into a report. When the Measures Drop Box 170 is selected, only those fields pertaining to the selected view, in the present example the Employee View 49, as designated in a Look in Drop Box 171, are available for selection. In the present example, the total number of employees in the Northwind database of FIG. 2 can be added to the Measures Drop Box 170. A user may also choose to follow one of the relations identified (see Balloon 172). In the present embodiment, a user chooses to follow a relation by double-clicking on the relation name. Should a user drag a relation name to the Measures Drop Area 170 or left-click on a relation name followed by clicking an Add Button 173 while the Measures Drop Area 170 is the default drop area, the DQR Application 100 will add the fields identified by a defaultAggregateFields Property V06 (See FIG. 3D) for the view to the Measures Drop Area 170.

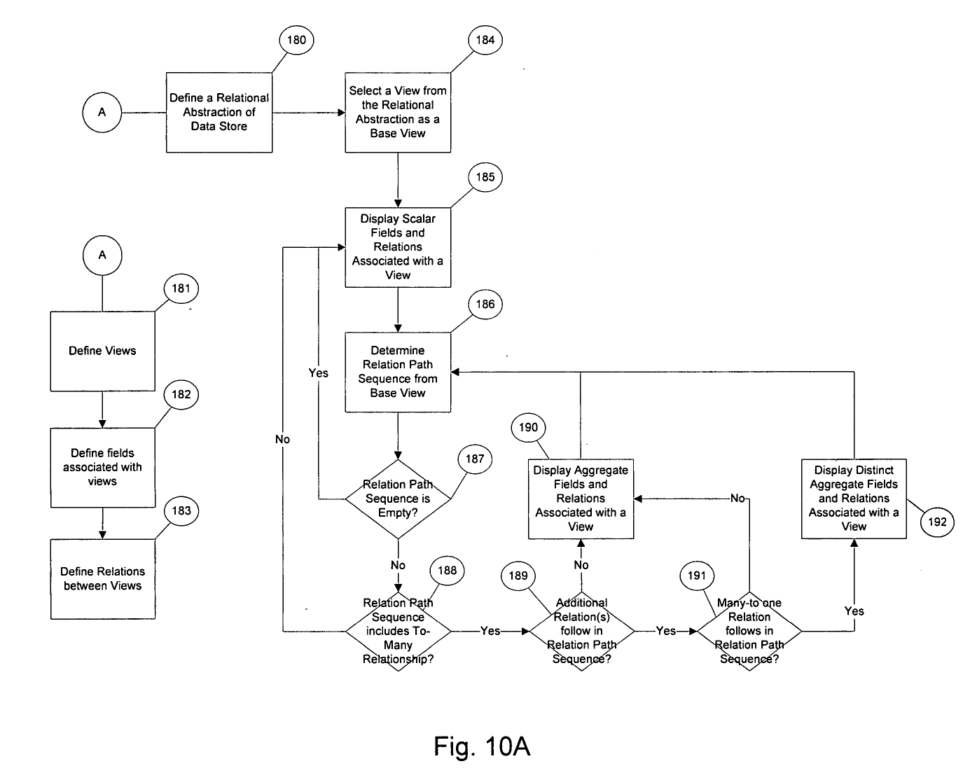

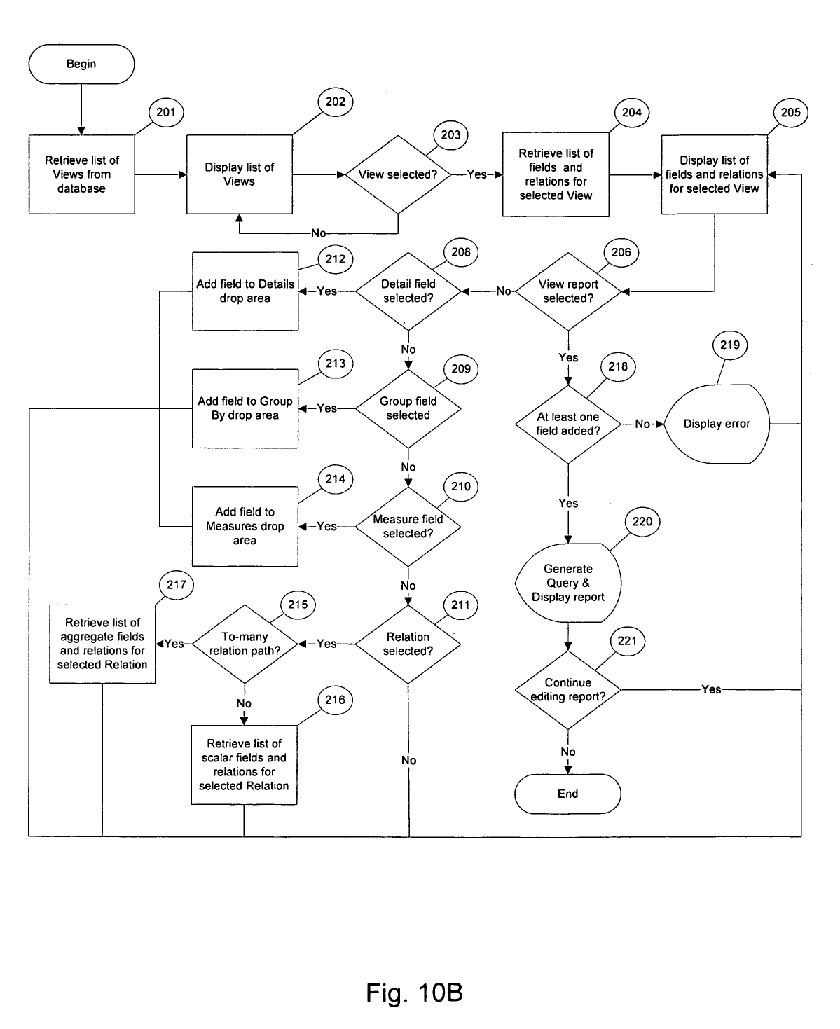

FIG. 10A displays a flowchart detailing the steps of operation of the method of constraining fields for display according to the present invention. In step 180, a relational abstraction of a data store is created. Steps 181, 182 and 183 describe the steps of creating the relational abstraction. In Step 181, views of the data to be available for access from the data store are created. In Step 182, fields to be associated with such views are defined. In Step 183, relations between views are defined. In one embodiment of the present invention, a metadata layer that references a database, such as the Northwind sample database, is created, as depicted in FIGS. 3A through 3E and as described above. One skilled in the art will recognize that a similar abstraction may be created for data stores of many types, including data stores that are not based upon relational database methodologies.

Once a relational abstraction of a data store has been created, fields may be displayed for selection. In Step 184, a view is selected as the base view. In step 185, scalar fields and relations of a view are displayed. In step 186, a relation path sequence is defined from the base view. According to step 187, if the relation path is empty, the scalar fields and relations associated with the base view are displayed. If the relation path is not empty, processing continues to step 188, where it is determined if the relation path sequence contains a to-many relationship. According to step 188, if the relation path sequence does not contain a to-many relationship, the scalar fields and relations associated with a destination view are displayed. Also according to step 188, if the relation path contains a to-many relationship, processing proceeds to step 189.

In step 189, the system determines if another relationship follows a to-many relationship in the relation path sequence according to step 188. If another relationship does not follow a to-many relationship in the relation path sequence, aggregate fields and relations associated with a destination view are displayed according to step 190 and processing returns to step 186. If another relationship follows a to-many relationship in the relation path sequence according to step 188, processing proceeds to step 191 where a determination is made about what type of relation follows.

In step 191, if other than a many-to-one relation follows a to-many relation according to step 188, processing proceeds recursively to step 190 where the aggregate fields and relations associated with a destination view are displayed. If in step 191 a many-to-one relation follows a to-many relation in the relation path sequence according to step 188, processing proceeds to step 192 where aggregate fields in a distinct aggregate context and relations associated with a destination view are displayed and processing returns recursively to step 186 for further processing.

FIG. 10B displays a flowchart detailing the steps of operation of the field display and selection grouping and display system according to one embodiment of the invention. In Step 201, an embodiment of the DQR Application 100 running on the Desktop Computer 1 requests a list of available databases and the lists of metadata views identified in FIGS. 3A, 3B and 3C, from the Query Engine 200 running on the Application Server 2. The Query Engine 200 responds with the names of available databases and views, including the Northwind example database described in FIG. 2, and displays them through the Window 96A shown in FIG. 6.

In step 202, the DQR Application 100 displays the name of the Northwind database described in FIG. 2 and a list of the other available databases in the Look In Drop Down Box 120 on the Display Device 19. Step 202 also displays the metadata views described in FIGS. 3A, 3B and 3C in the View List Box 121 through the Window 96B shown in FIG. 6A.

In Step 203, a user sequentially selects the Employee View 49 from the View Group List 123 and the Finish Button 124, which causes the YES branch of Step 203 to be followed. If a user does not select a view, the NO branch of Step 203 is followed and the DQR Application 100 continues to display the Window 96B of FIG. 6A.

In Step 204, the DQR Application 100 requests the fields and relations listed in the Employee View 49 from the Query Engine 200. In Step 205, the DQR Application 100 then displays the list of fields and relations of the Employee View 49 on the Display Device 19, displaying the Query Construction Window 130 described with reference to FIG. 7.

In Step 206, the DQR Application 100 awaits user input in the form of selecting fields, such as those highlighted by the Balloon 147, or relations, such as those highlighted by Balloon 149, of FIG. 7. If the View Report Button 138 is selected, the YES branch of step 206 is followed to Step 218. If no fields have been added, the NO branch of Step 218 is followed to Step 219, an error is displayed directing the user to select at least one field, and the DQR Application 100 continues to display the list of fields and relations of the selected view, such as the Employee View 49. If the user selects a field or relation, the DQR Application 100 proceeds to Step 208.

In Step 208, the DQR Application 100 monitors detail field selections. If a user does not select a detail field, the DQR Application 100 continues through the NO branch to Step 209. If a user selects a detail field, the DQR Application 100 proceeds through the YES branch to Step 212. In Step 212, the DQR Application 100 adds the name of the selected field to the Details Drop Box Area 143, and continues to Step 205 to display the fields and relations associated with the selected view.

In Step 209, the DQR Application 100 monitors group field selections. If a user selects a group field, the DQR Application 100 proceeds through the YES branch to Step 213. If a user does not select a group field, the DQR Application 100 continues through the NO branch to step 210.

In Step 210, the DQR Application 100 monitors measure field selections. If a user selects a measure field, the DQR Application 100 proceeds through the YES branch to Step 214. If a user does not select a measure field, the DQR Application 100 continues through the NO branch to Step 211.

In Step 211, the DQR Application 100 monitors the selection of relations. If a user selects a relation, the DQR Application 100 proceeds through the YES branch to Step 215. If a user does not select a relation, the DQR Application 100 continues through the NO branch to Step 205.

In Step 215, if the cardinality of the relation path ending with the selected relation is to-one, the DQR Application 100 follows the NO branch of Step 215 to Step 216. In Step 216, the DQR Application 100 retrieves the fields and relations associated with the followed relation and processing passes to Step 205. If the cardinality is to-many, the YES branch of Step 215 is followed to Step 217 where the DQR Application 100 limits retrieval of the fields associated with destination view to those fields that have a Field Type Property F07 (see FIG. 3D) set to “aggregate” and then processing is passed to Step 205. In this manner, the cardinality of the destination view relative to the base view constrains field selection. If the cardinality is to-many, only aggregated values associated with the destination view may be returned, thereby ensuring that each row returned by the DQR Application 100 represents exactly one row in the base view selected for the report.

In Step 218, if at least one field has been added to the report, the YES branch is followed to Step 220, where the DQR Application 100 verifies and generates a suitable database query and displays the report on the Display Device 19. In Step 221, if the Fields Button 134 is selected, the YES branch is followed to step 205. Otherwise the process terminates.

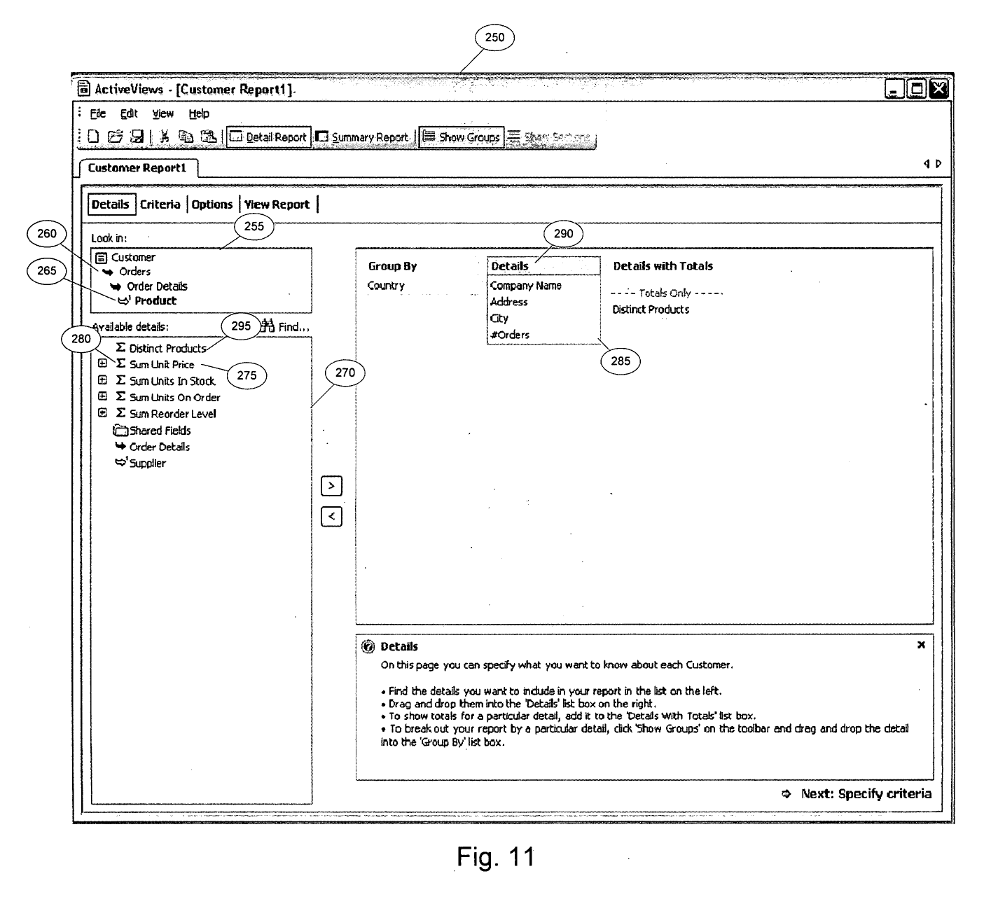

FIG. 11 depicts a Display Window 250 of another embodiment of the invention. In the depicted embodiment, the Look in: Box 255 provides a means of displaying a relation path and sequence from the base view to a view. The Black Arrow 160 provides a means of indicating that the relationship between the Customer View 40 (see FIG. 3A) and the Orders View 47 (see FIG. 3B) is a to-many relationship. The White Arrow 265 provides a means of indicating that the indicated relationship is a many-to-one relationship. The Available Details Box 270 provides a means of displaying available fields. Because the relation path of the present example contains a to-many relationship, as depicted by the Black Arrow 260, the Available Details Box 270 displays only aggregate fields, including the Sum Unit Price Field 275. The Symbol 280 provides a means of indicating that the Sum Unit Price Field 275 is an aggregate field and is an example of the method of the invention to display additional information about use of a field, which in the case of the Sum Unit Price Field 275 may be used to generate a total.

In the present example, the Column Drop Area 285 has been selected, as depicted by the darker grey surrounding the Details Text Description 290. When selected, the fields displayed in the Available details: Box 270 are constrained to those fields available for adding columns, according to the logic described with reference to FIG. 10A and FIG. 10B above.

In the present example, the relation path indicated in the Look in: Box 255 contains a to-many relation and a many-to-one relation. According to the logic described with reference to FIG. 10A and FIG. 10B, distinct aggregate fields are displayed for selection, including the Distinct Products Field 295.

It will be obvious to those of skill in the art that the invention described in this specification and depicted in the FIGURES may be modified to produce different embodiments of the present invention. Thus, the present invention has several advantages over the prior systems without sacrificing any of the advantages of those prior systems. Although two embodiments of the invention have been illustrated and described, various modifications and changes may be made by those skilled in the art without departing from the spirit and scope of the invention.

1. A method for displaying a relational abstraction of a data store, comprising the steps of:
a) defining a relational abstraction of a data store, the definition including a plurality of views, scalar or aggregate fields associated with the views, and relations between the views; and
b) displaying the fields and relations associated with a view related to a base view through a sequence of one or more relations.

2. The method of claim 1 wherein the view is the base view and the sequence of relations is empty.

3. The method of claim 1 wherein the fields displayed are constrained to scalar fields where the sequence of relations does not contain a to-many relation.

4. The method of claim 1 wherein the fields displayed are constrained to aggregate fields where the sequence of relations contains at least one to-many relation.

5. The method of claim 1 wherein a field is displayed with additional information indicating at least one way the field may be used.

6. The method of claim 5 wherein an aggregate field is displayed with additional information indicating it may be used to generate a total.

7. The method of claim 5 wherein a field for which grouping is meaningful is displayed with additional information indicating the field may be used for grouping.

8. The method of claim 1 wherein the fields displayed are constrained to those which may be used in a predetermined way.

9. The method of claim 8 wherein the fields displayed are constrained to aggregate fields when a selected field will be used to generate a total.

10. The method of claim 8 wherein the fields displayed are constrained to those for which grouping is meaningful when a selected field will be used for grouping.

11. The method of claim 1 wherein additional information is displayed indicating there may be one or many items in a related view associated with a single item in a previous view in the relation sequence.

12. The method of claim 1 wherein additional information is displayed indicating there may be duplicate items in a related view associated with a single item in a previous view in the relation sequence.

13. The method of claim 1 wherein the means of displaying the fields associated with a view is any means of displaying hierarchical data.

14. The method of claim 13 wherein the means of displaying the fields associated with a view is a tree.

15. The method of claim 13 wherein the means of displaying the fields associated with a view is a list.

16. The method of claim 1 wherein the means of displaying the relations originating from a view is any means of displaying hierarchical data.

17. The method of claim 16 wherein the means of displaying the relations originating from a view is a tree.

18. The method of claim 16 wherein the means of displaying the relations originating from a view is a list.

19. The method of claim 1 wherein the sequence of relations is displayed.

20. The method of claim 19 wherein the means of displaying the sequence of relations is a list.

21. The method of claim 19 wherein the means of displaying the sequence of relations is a delimited path.

22. The method of claim 19 wherein the means of displaying the sequence of relations is a natural language description.

23. The method of claim 8 wherein the means of specifying a predetermined field usage is the selection of a target area.

24. The method of claim 8 wherein the means of specifying a predetermined field usage is a plurality of buttons.

25. The method of claim 8 wherein the means of specifying a predetermined field usage is a plurality of menu items.

26. A computer system for displaying a relational abstraction of a data store, the system comprising:
a) means for defining a relational abstraction of a data store, the definition including a plurality of views, scalar or aggregate fields associated with the views, and relations between the views; and
b) means for displaying the fields and relations associated with a view, the view comprising a base view or a view related to a base view through a sequence of one or more relations.
